(19) United States
(12) Patent Application Publication
(10) Pub. No.: US 2016/0379238 A1
(43) Pub. Date: Dec. 29, 2016

(54) VIRTUAL REDEEMABLE INSTRUMENTS

(71) Applicant: Calay Venture S.à r.l, Bettembourg (LU)

(72) Inventor: Cevat Yerli, Frankfurt am Main (DE)

(73) Assignee: Calay Venture S.à r.l., Bettembourg (LU)

(21) Appl. No.: 14/749,276

(22) Filed: Jun. 24, 2015

(51) Int. Cl. G06Q 30/02

(52) U.S. Cl. CPC G06Q 30/0207

(57) ABSTRACT

A method of processing redeemable instruments, such as virtual scratch cards or virtual coupons, is described. A redeemable instrument is delivered to a first electronic device. The redeemable instrument includes a user interface configured to react to a redemption activity of a user, the redemption activity causing redeemable instrument information of the redeemable instrument to be first provided to the user. Furthermore, it is determined that the redeemable instrument has been redeemed using a second electronic device different from the first electronic device, and recorded that the redeemable instrument has been redeemed. Furthermore, a computer system for processing redeemable instruments is described.

### FIELD

The present disclosure relates to a method and a computer system for processing redeemable instruments, such as virtual scratch cards or virtual coupons.

### BACKGROUND

Conventional scratch cards are physical entities comprising one or more areas on which information is printed. The information is concealed by an opaque panel which can be scratched off to reveal the information.

In some instances, the information may relate to a win or lose outcome in gambling, thus indicating a loss or a payout. In the latter case, the information may effect the disbursement of a gain when it is presented for the first time to a provider of the gambling service. In other examples, similar to information printed on a coupon, the information may serve as a one-time password (such as a code number) which, when being entered into some device for the first time, releases some service, credit or access right such as a phone service or other prepaid service.

A recipient of such a conventional scratch card or coupon may, for example, copy the information and input it into some electronic device, or he or she may present it to another person. Alternatively, the recipient may pass on the scratch card or coupon to another person who may use the information accordingly. Once the information is thus used, it is voided. Often, the mere fact that the opaque panel of a scratch card has been scratched off indicates that the scratch card has been devaluated. On the other hand, the information being covered by the panel assures a holder or recipient of the scratch card that the information has not been used so far and thus is still valid.

Due to the specified applicability of the revealed information on the scratch cards, the concept of distributing scratch cards provides for a controlled allocation of rights or other advantages.

However, the concept of such conventional scratch cards relies solely on physical distribution channels, such as inserts in magazines, newspapers or periodicals, or inclusions with delivery notes, direct mail-outs, indirect mail-outs, physical handouts from an individual to a potential customer, or physical attachment to a product. These delivery methods are expensive, require long planning cycles, have very long lead times and are impossible to adjust or to alter once a campaign is up and running.

There is, therefore, a need for a technique supporting a more diversified and flexible allocation of benefits.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

According to the present disclosure, one or more of the above issues may be solved by a method of processing redeemable instruments, by one or more computer readable media, and by a computer system for processing redeemable instruments.

According to a first aspect of the present disclosure, a method of processing redeemable instruments is disclosed, wherein the method comprises delivering a redeemable instrument to a first electronic device, wherein the redeemable instrument includes a user interface configured to react to a redemption activity of a user, the redemption activity causing redeemable instrument information of the redeemable instrument to be first provided to the user, determining that the redeemable instrument has been redeemed using a second electronic device different from the first electronic device, and recording in a memory that the redeemable instrument has been redeemed.

According to a second aspect of the present disclosure, at least one computer readable medium stores instructions which, when executed by a computer device connected to a communications network connected to a first and a second electronic device, enable the computer device to process redeemable instruments in accordance with the method of the first aspect of the present disclosure.

According to a third aspect of the present disclosure, a computer system for processing redeemable instruments comprises at least one server device configured to communicate with a first and second electronic device via a communications network, wherein the server device is configured to deliver a redeemable instrument to the first electronic device, wherein the redeemable instrument includes a user interface configured to react to a redemption activity of a user, the redemption activity causing redeemable instrument information of the redeemable instrument to be first provided to the user, observe whether the redeemable instrument has been redeemed using the second electronic device, and if so, record in a memory that the redeemable instrument has been redeemed.

According to an embodiment, the redeemable instrument can be a virtual redeemable instrument. Preferably, the redeemable instrument is a virtual scratch card or a virtual coupon. In the following description, embodiments and examples of the present disclosure may refer to a scratch card or a virtual scratch card. However, it is to be understood that the respective embodiments and examples may also be used with a redeemable instrument of any type, such as a coupon.

In response to the redemption activity, according to embodiments, the scratch card information is first (i.e., for the first time) provided to the user. Accordingly, the scratch card information is kept unrecognizable (in particular, invisible and inaudible) until completion of the redemption activity.

The redemption activity may include, for example, a swiping movement made with a moveable input device (such as a computer mouse), or with a finger or stylus on a touch pad or touch screen. In such examples, when the scratch card information is devised for visual provision, the redemption activity may virtually reveal the scratch card information gradually in accordance with the swiping movement.

Additionally or alternatively, the redemption activity may comprise a click on a button, or another interaction with an input device.

The scratch card information may indicate that the virtual scratch card has been a blank or loss not providing any benefit. Alternatively, the scratch card information may indicate that the virtual scratch card provides a benefit such as a discount in some transaction, or it may indicate some PIN, discount code or phone number that may provide for some advantage when it is entered in some device or presented to another person. The scratch card information may be provided in codified form (such as a barcode or a QR code) that can be presented to a scanning device to provide some advantage.

Data encoding the scratch card information may be included in the virtual scratch card, or it may be delivered separately, e.g., upon determining that the virtual scratch card has been redeemed using the second electronic device. The virtual scratch card may be delivered through one or more social networking sites or platforms.

Accordingly, the various aspects provide a technique for processing redeemable instruments, such as virtual scratch cards, which overcomes the above drawbacks of conventional scratch cards. The virtual scratch cards allow for a flexible allocation of benefits. In particular, they allow for an improved control and tracking of a course that a passed-on scratch card is taking, and for a modification of one or more associated privileges subsequent to issuing the virtual scratch card.

Preferably, the virtual scratch card is identified by a unique identification code. The identification code may be included in the delivered scratch card. Alternatively, the unique identification code may be generated in response to the redemption activity.

Such unique identification allows for a precise recording, tracking and devaluating of the scratch card. The unique identification code may be associated with the scratch card information.

According to an embodiment, the method according to the first aspect comprises updating the virtual scratch card before determining that the virtual scratch card has been redeemed, by replacing previous scratch card information with the updated scratch card information. Analogously, the at least one computer readable medium preferably comprises respective instructions, and the server device included in the computer system according to the third aspect is preferably adapted to update the virtual scratch card accordingly.

The updating may be carried out, for example, responsive to some event, such as a time-out, a determination that a current holder of the scratch card is among a predetermined set of users or has one or more particular properties, or responsive to a notification received, e.g., from a publisher of the virtual scratch card.

This embodiment allows for an advantageous adjustment of a given campaign according to particular trends, needs, etc. For instance, the scratch card information may be associated with a unique identification code of the virtual scratch card, and the association may be registered in a memory. The updating may thus comprise updating a record, in the register, related to the unique identification code accordingly.

The updated virtual scratch card may be delivered to the second electronic device.

According to an embodiment, the virtual scratch card is associated with at least one privilege.

Such a privilege may relate, for instance, to an action, such as an electronic transaction. In such a case, the privilege may, for example, provide for some safety improvement in the electronic transaction. In a case where the action comprises a billable transaction, the privilege may effect a price reduction for the user of the second electronic device redeeming the virtual scratch card.

As further examples, a privilege may relate to access rights to one or more data sources, to an interactive session (such as a session within a social networking service that a user redeeming the virtual scratch card may wish to participate in), or to a video game (in which case the privilege may effect an improved game level for the user redeeming the virtual scratch card).

The virtual scratch card may further include data enabling the second electronic device to implement the at least one privilege.

Additionally or alternatively, the method may comprise conferring the at least one privilege to a user of the second device who has redeemed the virtual scratch card. Analogously, the at least one computer readable medium may include respective instructions, and the server device may be adapted to confer the at least one privilege accordingly.

This embodiment provides the advantage that the server device may control the conferment of the privilege(s), and the delivered virtual scratch card may be a small data entity which can be easily dispatched and passed on, as it may be disburdened from a main data package that can instead be queried when the virtual scratch card is indeed redeemed.

Conferring the at least one privilege to a user of the second device may include delivering data required for the second electronic device implementing the at least one privilege.

For instance, when the privilege is related to consuming a video, the conferring may include delivering streamed video data to the second electronic device.

When the privilege relates to an interactive session as mentioned above, conferring the privilege may comprise establishing a connection of the second electronic device to the interactive session. When the privilege relates to access rights to one or more data sources (such as a data source stored in a memory of the server device), conferring the privilege may comprise providing the user of the second electronic device with such an access right.

In a case where the privilege relates to an action initiated by the user of the second electronic device as mentioned above, conferring the at least one privilege to the second electronic device may comprise modifying one or more parameters related to said activity; therein, the one or more parameters may be recorded in a database stored in a memory of the server device. For instance, the one or more parameters may refer to a price in an electronic transaction initiated by the user of the second electronic device.

An allocation associating the scratch card information or the unique identification code, or both, with the at least one privilege may be stored in a memory (e.g., of the server device or accessible by the server device), and accordingly, the method may include storing such allocation. This embodiment allows for a centralized control of the allocation of privileges by means of the virtual scratch cards, thus permitting proactive and dynamical adjustments.

According to an embodiment, recording that the virtual scratch card has been redeemed comprises recording an identification of a user of the second electronic device or of the second electronic device.

Preferably, the method further comprises keeping a record of at least one current holder of the virtual scratch card in a memory. The method may comprise storing and matching user data of the user of the first electronic device, or of the user of the second electronic device, or of both. In particular, it may comprise collecting, recording and computing data about interactions of said users, about their friends registered in some data base and about redemptions made.

For instance, the method according to the first aspect may comprise keeping and updating a register with respect to one or more of: a current holder of the virtual scratch card, a user of the second electronic device redeeming the virtual scratch card, a user of a third electronic device trying to redeem the virtual scratch card, users that the user of the first electronic device is interacting with, and users that the user of the second electronic device is interacting with. Analogously, the at least one computer readable medium according to the second aspect may comprise respective instructions, and the server device of the computer system according to the second aspect may be adapted to keep and update a register accordingly. The register may be stored in a memory, e.g., in a memory included in or accessible by the server device, such as by way of a communications network.

Thereby, targeted campaigns are made possible. In particular, the at least one privilege associated with the virtual scratch card may be updated based on the current holder or based on collected, recorded or computed data, or a further virtual scratch card may be created and delivered based on such data.

The virtual scratch card may be configured so as to cause a notification to be sent to a (or the) server device when a user of the first electronic device passes on or has passed on the virtual scratch card. For example, the virtual scratch card may be configured so as to interact with a messaging environment (such as an email program or a social networking service), and to thereby cause the messaging environment to send the notification when the virtual scratch card is up to be passed on, is being passed on, is being received or has been received by means of the messaging environment.

According to an exemplary embodiment, the method comprises receiving, from the first electronic device, a message indicating that the first electronic device has passed on the virtual scratch card to the second electronic device, or indicating that the first electronic device has passed on the virtual scratch card to a third electronic device.

Additionally or alternatively, the method may comprise receiving, from the second or from a (or the) third electronic device, a notification indicating that the second or the third electronic device, respectively, has received the virtual scratch card from the first electronic device.

These embodiments allow for tracking the virtual scratch card and, therewith, for accurate in-campaign and post-campaign monitoring and analysis.

Preferably, as long as the virtual scratch card has not been redeemed, a recipient of the virtual scratch card, e.g., a user of the first electronic device, can freely pass on the virtual scratch card to his or her friends or to the general public. Thus, the virtual scratch card may be passed on an arbitrary number of times. In particular, the method may include recording in a memory, prior to determining that the virtual scratch card is redeemed using the second electronic device, that the virtual scratch card is being held by both a user of the second electronic device and a user of a third electronic device. Thus, the virtual scratch card may be passed on concurrently to various users.

According to an embodiment, the method comprises determining that the user of the first electronic device has signed up (also referred to herein as registered) for receiving the virtual scratch card. Analogously, the at least one computer readable medium may include respective instructions, and the server device according to the third aspect may be adapted to determine such signing up. The determining may comprise querying a database recording users who have registered themselves accordingly. As a consequence, the virtual scratch card can be delivered in a target-oriented way to appropriate users.

The signing up may comprise a conventional registering procedure, such as the user of the first electronic device entering a name, an email address or an identifying number into a database. Additionally or alternatively, the signing up may comprise scanning some code (such as a barcode or a QR code) with an optical device such as a camera of a mobile phone, a smart phone or a tablet computer; preferably, the signing up can be realized solely by such scanning.

According to an embodiment, the communications network and the computer system may be running a social networking service. In such an embodiment, the virtual scratch card is preferably delivered or passed on using the social networking service. Additionally or alternatively, at least one privilege that may be associated with the virtual scratch card may relate to features of the social networking service. For instance, it may provide a recipient thereof with additional or improved tools to be used within the social networking service, such as an enhanced data connection or some merit in a real or virtual event operated by means of the social networking service.

Preferably, the method further comprises delivering, to the first electronic device, a notification including information related to the fact that the virtual scratch card has been redeemed. Analogously, the server device is preferably configured to deliver such notification. The information may, for instance, include an indication of the second electronic device, or of a user of the second electronic device who has redeemed the virtual scratch card. For instance, the notification may be delivered using a social networking service.

According to an embodiment, recording in a memory that the virtual scratch card has been redeemed comprises devaluating the virtual scratch card.

Accordingly, recording that the virtual scratch card has been redeemed may comprise updating the virtual scratch card by replacing a privilege associated with the virtual scratch card by at least one other privilege, e.g., by a void privilege.

Additionally or alternatively, said recording may comprise causing that the virtual scratch card is deleted on the second electronic device. Preferably, the recording even comprises causing that the virtual scratch card is deleted on any electronic device registered in a memory as a current holder of the virtual scratch card. Thereby, a devaluation is made possible also in cases where the virtual scratch card has been passed on concurrently to various electronic devices.

As a further example, the method according to the first aspect may include receiving a notification indicating that redemption of the virtual scratch card is attempted using a third electronic device, querying the memory to determine that the virtual scratch card has been redeemed already and refusing a conferment of at least one privilege associated with the virtual scratch card to the third electronic device. The refusal may include sending a notification to the third electronic device, the notification indicating that the virtual scratch card is invalid, for it has been redeemed already. As is to be understood, the at least one computer readable medium may analogously include instructions which cause the computer device to carry out such steps, and the server device of the computer system according to the third aspect may be adapted to do so.

Additionally or alternatively, recording that the virtual scratch card has been redeemed may include inhibiting that the virtual scratch card is further passed on. For instance, the recording may include inhibiting that the second electronic device further forwards the virtual scratch card.

The various embodiments provide several advantages. In particular, allowing the passing on of redeemable instruments, such as virtual scratch cards or virtual coupons, creates value and awareness of a product, service or brand of a business or company and of social networking sites or platforms. The technique provided by the present embodiment is highly efficient and inexpensive to implement and run.

As is to be understood, some or several of the features described herein may be combined with each other. In particular, the server device of the system of the third aspect may be adapted to carry out one or more of the particular embodiments of the method according to the first aspect of the present disclosure. Analogously, the one or more computer readable media may include instructions which, when executed by a computer, carry out any of the embodiments of the method according to the first aspect.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 depicts an exemplary method in accordance with one embodiment of the present disclosure;

FIG. 2 shows an exemplary record scheme and a data structure representing a virtual scratch card;

FIG. 3 depicts a system including a server device in accordance with an embodiment of the present disclosure.

### DETAILED DESCRIPTION

While illustrative embodiments have been illustrated and described, it will be appreciated that various changes can be made therein without departing from the spirit and scope of the invention.

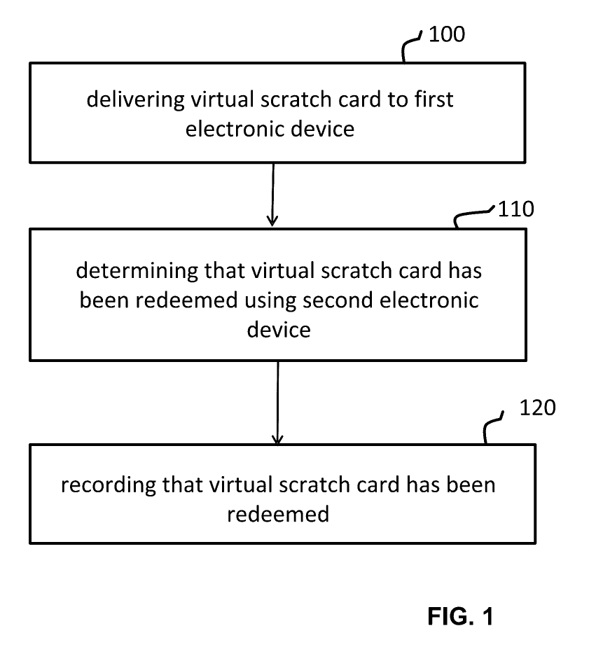

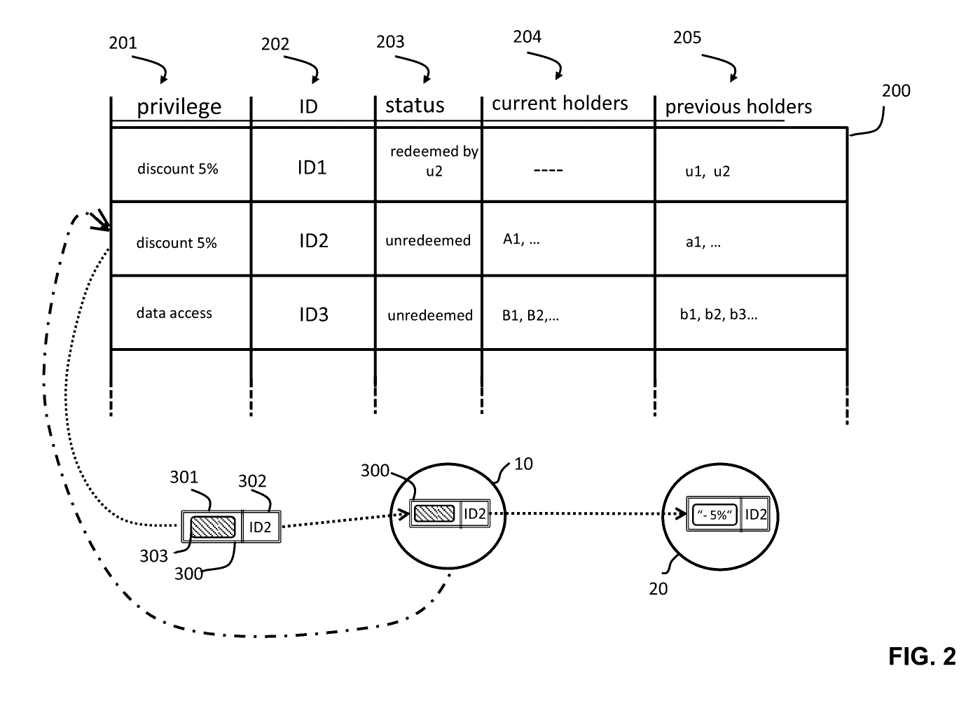

As schematically illustrated in FIG. 1, a method according to the present disclosure includes a step 100 of delivering a virtual scratch card to a first electronic device. As detailed above and further illustrated in FIG. 2, the virtual scratch card includes a user interface receptive for a redemption activity of a user, the redemption activity causing scratch card information to be first provided to the user. The virtual scratch card may be associated with a unique identification code that identifies the virtual scratch card, or with at least one privilege or with both. The virtual scratch card may have been created based on a request received from a scratch card publisher.

The virtual scratch card including the user interface may be visually represented on a display of the first electronic device. The representation may include the user interface which may comprise a button, wherein the redemption activity may be realized by or include clicking on the button. Additionally or alternatively, the user interface may comprise a field receptive for a swiping movement of a user with a movable device or with a finger, wherein the redemption activity may be realized by or include the swiping movement.

In step 110, it is determined that the virtual scratch card has been redeemed using a second electronic device; this may be a result of the first electronic device passing on the virtual scratch card.

In step 120 it is recorded in a memory that the virtual scratch card has been redeemed. The recording allows for devaluating the virtual scratch card; indeed, when an attempt of redeeming the virtual scratch card is determined later on, the memory may be queried, and it may be determined that the virtual scratch card has been redeemed already. As a consequence, a conferment of the at least one privilege associated with the virtual scratch card may be refused. Further steps possibly included in the method are detailed herein.

FIG. 2 schematically shows a record scheme that may be stored in a memory of an electronic device, e.g., of a server device of a computer system in accordance with an aspect of the present disclosure. As depicted in FIG. 2, a table 200 relates to various virtual scratch cards that may be delivered to appropriate users. The users may have registered themselves in a database as being interested in receiving scratch cards; the registering may include specifying a particular publisher or a particular type of scratch card the user is interested in. As detailed above, the registering may, in particular, be realized by scanning a particular information (such as a number, a barcode or a QR code) with a digital camera, e.g., with a camera of a smart phone or other electronic device.

As depicted in FIG. 2, each scratch card is identified by a respective unique identification code. In the exemplary table shown, the identification codes are registered in column 202.

Moreover, the table specifies various privileges associated with each scratch card, wherein a respective privilege may be granted to a user carrying out the redemption activity; in the exemplary table shown, the privileges are recorded in column 201. The exemplary privileges indicated relate to a 5% discount that may be granted to a user in a billable transaction, and to a data access privilege, e.g., to a right of accessing a video database.

Further stored in the table 200 are parameters related to a current state and history of the virtual scratch cards identified by the respective unique identification codes. For instance, as can be recognized from column 203, the virtual scratch card having the identification code ID1 has been redeemed already, whereas the virtual scratch cards having identification codes ID2 and ID3, respectively, are still unredeemed.

As the redemption of the virtual scratch card having the identification code ID1 has caused a devaluation of the virtual scratch card, there is no current holder of this virtual scratch card recorded in column 204. Previous holders of this virtual scratch card have been users “u1” and “u2,” as recorded in column 205. Indeed, it has been user u2 who has redeemed the virtual scratch card having ID1, as is further registered in column 203.

The path of the virtual scratch card 300 identified by the unique identification code ID2 is exemplarily depicted in the bottom of FIG. 2. As indicated by the dotted arrow, the virtual scratch card 300 has been delivered to a first electronic device 10 which may be used by previous holder a1. The previous holder a1, however, has passed on the virtual scratch card 300 to user A1 of a second electronic device 20, which user in the situation depicted is a current holder of the virtual scratch card.

As indicated in field 302 of the virtual scratch card 300, the virtual scratch card includes the identification code ID2. Additionally, in field 301 the virtual scratch card 300 includes a user interface 303 which is receptive of a redemption activity of a user.

As can be seen in table 200, the scratch card identified by ID2 relates to a privilege which in the present case confers a 5% discount in a billable transaction. Accordingly, the scratch card information to be presented to a redeeming user may indicate that such discount is granted to a redeeming user. Alternatively or additionally, the scratch card information may include a code a user may present within a transaction in order to enjoy the privilege.

The scratch card information is provided to a user for the first time when the user has redeemed the virtual scratch card. Accordingly, as indicated in FIG. 2, when the virtual scratch card is delivered to the first electronic device 10 and passed on therefrom, the scratch card information is still unrecognizable. However, when the virtual scratch card has been redeemed using electronic device 20, the scratch card information (schematically indicated by “−5%” in the figure) is provided to the user of the second electronic device.

When the virtual scratch card is passed on using the first electronic device 10, a respective notification is sent to a server device storing the table 200, as indicated by the discontinuous arrow starting from first electronic device 10. According to an alternative embodiment, a respective notification may be sent from the second electronic device upon receiving the virtual scratch card 300. Due to the notification, the server device can update the table 200.

Moreover, in cases where the privilege associated with the virtual scratch card has been modified (not shown), e.g., by a scratch card publisher adapting a related campaign to recent developments, the server device may update table 200 so as to include the association of the virtual scratch card with the modified privilege. The server device may deliver an updated virtual scratch card to the current holder Al using the second electronic device. For example, when the virtual scratch card is updated such that the unique identification is associated to a 7% discount, updated scratch card information referring to the modified discount may be provided to the user Al of the second electronic device once he or she has redeemed the virtual scratch card.

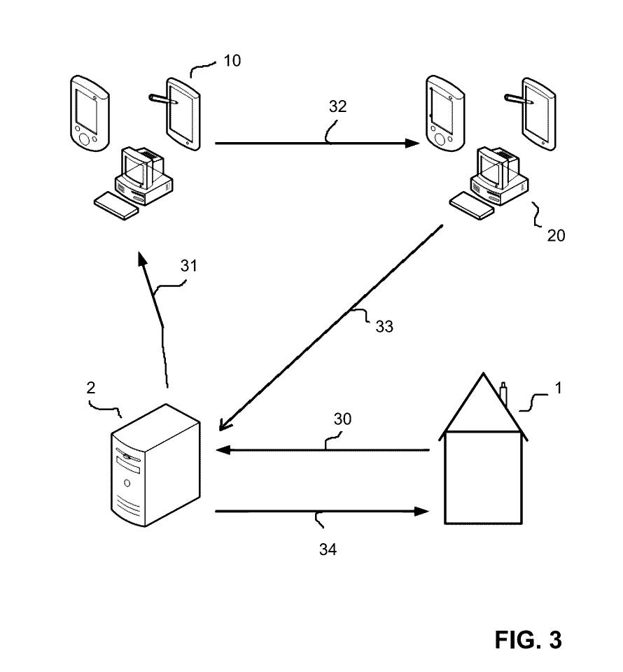

FIG. 3 shows an exemplary system and a set of communications among the included entities in accordance with the present disclosure. Some or all of the communications may be operated by employing a social networking service.

The system includes a scratch card publisher 1 activating a server device 2. Accordingly, by an operation 30, the scratch card publisher 1 may cause the server device 2 to create a set of virtual scratch cards and to deliver the virtual scratch cards to certain users; as mentioned above, the users may have registered themselves as being interested in receiving scratch cards from the scratch card publisher 1. The operation 30 may identify the respective devices of the users, or it may specify the users by certain characteristics, in particular by a reference to a database recording registered users.

As a consequence, the server device 2 may create the virtual scratch cards and deliver them, within a communication 31, to the various first electronic devices 10. Each of the virtual scratch cards may include a unique identification code identifying the respective virtual scratch card.

The server device 2 may keep a table such as table 200 depicted in FIG. 2, the table referring to various virtual scratch cards, unique identification codes and privileges respectively associated therewith, a respective redemption status and previous and current holders of the virtual scratch card.

A user of a first electronic device 10 may not be interested in a privilege offered by means of the virtual scratch card, and within a communication 32, he or she may thus pass on the virtual scratch card to a second electronic device 20. A user of the second electronic device 20 may indeed redeem the virtual scratch card, and in a transmission 33, the server device 2 may be informed about the redemption. As a consequence, the server device records the redemption. Preferably, the server device further records data identifying the second electronic device or of a user thereof or of both. The server device 2 may send a further transmission (not shown) to the first electronic device, the transmission including a notification that the virtual scratch card has been redeemed using the second electronic device. Moreover, as indicated by arrow 34, the server device may provide (e.g., display) information to the scratch card publisher, informing the scratch card publisher about the redemption of the virtual scratch card by using the second electronic device. Additionally or alternatively, the server device may provide information related to a path the virtual scratch card has taken (e.g., represented by previous holders of the scratch card) or to user characteristics of previous or current users (such as registered friends or recent or frequent activities of the users).

As a consequence, the scratch card publisher is kept informed about the course of the virtual scratch cards, and can adjust a present or future campaign accordingly.

While some embodiments have been described in detail, it is to be understood that the aspects of the present disclosure can take many forms. In particular, the claimed subject matter may be practiced or implemented differently from the examples described and the described features and characteristics may be practiced or implemented in any combination. The embodiments shown herein are intended to illustrate rather than to limit the invention as defined by the claims.

The embodiments of the invention in which an exclusive property or privilege is claimed are defined as follows:

1. A method of processing redeemable instruments, the method comprising:
delivering a redeemable instrument to a first electronic device, wherein the redeemable instrument includes a user interface configured to react to a redemption activity of a user, the redemption activity causing redeemable instrument information of the redeemable instrument to be first provided to the user;
determining that the redeemable instrument has been redeemed using a second electronic device different from the first electronic device; and
recording in a memory that the redeemable instrument has been redeemed.

2. The method of claim 1, further comprising identifying the redeemable instrument using a unique identification code.

3. The method of claim 1, further comprising updating the redeemable instrument by replacing previous redeemable instrument information with the redeemable instrument information, prior to determining that the redeemable instrument has been redeemed.

4. The method of claim 1, wherein the redeemable instrument is associated with at least one privilege, the method further comprising conferring the at least one privilege to a user of the second electronic device.

5. The method of claim 4, wherein conferring the at least one privilege to the user of the second electronic device comprises one or more of:
modifying one or more parameters related to an action initiated by the user of the second electronic device;
providing the user of the second electronic device with an access right to one or more data sources;
establishing a connection of the second electronic device to an interactive session; and
improving a level in a video game running on the second electronic device.

6. The method of claim 1, wherein recording in a memory that the redeemable instrument has been redeemed comprises inhibiting that the redeemable instrument is further passed on to another electronic device.

7. The method of claim 1, further comprising receiving a notification indicative of passing on, by the first electronic device, the redeemable instrument to the second electronic device or to a third electronic device.

8. The method of claim 1, further comprising keeping a record of a current holder of the redeemable instrument in a memory.

9. The method of claim 1, wherein the redeemable instrument is delivered using a social networking service.

10. The method of claim 1, further comprising determining that a user of the first electronic device has signed up for receiving the redeemable instrument.

11. The method of claim 1, further comprising delivering, to the first electronic device, a notification indicative of redemption of the redeemable instrument.

12. The method of claim 1, further comprising maintaining a register for the redeemable instrument including information on one or more of:
a current holder of the redeemable instrument;
a user of the second electronic device redeeming the redeemable instrument;
a user of a third electronic device trying to redeem the redeemable instrument;
one or more users interactively connected to the user of the first electronic device; and
one or more users interactively connected to the user of the second electronic device.

13. The method of claim 1, wherein the redeemable instrument is a virtual scratch card.

14. One or more computer readable non-transitory media comprising instructions which, when executed by a computer device connected to a first and second electronic device via a communications network, cause the computer device to:
deliver a redeemable instrument to the first electronic device, wherein the redeemable instrument includes a user interface configured to react to a redemption activity of a user, the redemption activity causing redeemable instrument information of the redeemable instrument to be first provided to the user;
determine that the redeemable instrument has been redeemed using the second electronic device, which is different from the first electronic device; and
record in a memory that the redeemable instrument has been redeemed.

15. A computer system for processing redeemable instruments, the system comprising at least one server device configured to communicate with a first and second electronic device via a communications network, wherein the at least one server device is configured to:
deliver a redeemable instrument to the first electronic device, wherein the redeemable instrument includes a user interface configured to react to a redemption activity of a user, the redemption activity causing redeemable instrument information of the redeemable instrument to be first provided to the user;
observe whether the redeemable instrument has been redeemed using the second electronic device;
and if so, record in a memory that the redeemable instrument has been redeemed.

16. The system of claim 15, wherein the at least one server device is further configured to determine that a user of the first electronic device has signed up for receiving the redeemable instrument.

17. The system of claim 15, wherein the at least one server device further comprises a register configured to store information on one or more of:
a current holder of the redeemable instrument;
a user of the second electronic device redeeming the redeemable instrument;
a user of a third electronic device trying to redeem the redeemable instrument;
one or more users interactively connected to the user of the first electronic device; and
one or more users interactively connected to the user of the second electronic device.

18. The system of claim 15, wherein the at least one server device is further configured to update the redeemable instrument by replacing previous redeemable instrument information with the redeemable instrument information.

19. The system of claim 15, wherein the redeemable instrument information is associated with at least one privilege, and wherein the at least one server device is further configured to confer the at least one privilege to the second electronic device in response to redemption of the redeemable instrument using the second electronic device.

20. The system of claim 15, wherein the server device is further configured to send a notification to the first electronic device, the notification including information related to redemption of the redeemable instrument.

21. The system of claim 15, wherein the redeemable instrument is a virtual scratch card.
